(19) United States
(12) Patent Application Publication
(10) Pub. No.: US 2003/0078854 A1
(43) Pub. Date: Apr. 24, 2003

(54) System and method for providing advertisement and technical skill premium by using network

(76) Inventor: Young-Up Shim, Seoul (KR)

Correspondence Address: PERKINS COIE LLP, PATENT-SEA, P.O. BOX 1247, SEATTLE, WA, 98111-1247, US

(21) Appl. No.: 10/220,137

(22) PCT Filed: Mar. 6, 2001
(86) PCT No.: PCT/KR01/00342

(30) Foreign Application Priority Data
Mar. 6, 2000 (KR) 2000/11102
Oct. 30, 2000 (KR) 2000/63992

(51) Int. Cl. G06F 17/60

(52) U.S. Cl. 705/26

(57) ABSTRACT

The present invention relates to the system and method providing the advertisement and the technical skill premium by using the network, comprising the steps of previously registering premiums provided by at least one selected from a group consisting of member companies; previously storing advertisements corresponding to registered premiums; storing at least one selected from a group consisting of questions; receiving selection information from a user's terminal about special premiums in at least one selected from a group consisting of the registered premiums; searching for the advertisements according to the selected premiums; randomly extracting the appointed number of the questions in at least one selected from a group consisting of the stored questions; transmitting the searched advertisements and the extracted questions to the user's terminal; receiving answers corresponding to the questions from the user's terminal: storing the received answers; and transmitting information to the user's terminal about lottery results judging whether or not the user wins any premiums.

### TECHNICAL FIELD

The present invention relates to a system and method for providing advertisement and technical skill premium by using network. More especially, it relates to the system and method for providing the advertisement and the technical skill premium by using network that provides a suitable user various kinds of information selectively and then improves overall effectiveness of advertisement and the validity of information the present invention provides.

### BACKGROUND ART

Generally, Internet advertisements are successive actions in which special companies register advertisement data made to promote a company's image or sell goods using a medium like the Internet, and disclose the corresponding data to a plurality of members using that medium.

Through these Internet advertisements, the corresponding company avoids the necessity of visiting users individually to provide information about a company or its products, and also achieves its advertising objectives within a short time. Moreover, the limitations of advertisement using other broadcasting media are overcome.

In other words, if a user simply connects to the Internet, advertisement data is provided to the corresponding user without any limitations of time or space.

And, as mentioned above, because of its ability to transcend time and space, if advertisement data is registered on the Internet, any user on Earth can read that data. Therefore the service provider (the user) takes a serious view of the Internet advertisement.

Moreover, Internet advertisements are cheaper, more practical, and more effective than other advertisement media. As a result, Internet advertisements are becoming increasingly common.

Of course, the company that creates Internet advertisements provides coupons through its advertisements enabling people to use the corresponding company by means of the Internet and offering the premiums to attract the interest of many users.

Below, we will describe in brief a method for advertising on the Internet that is gradually being recognized as an effective method of advertising.

The following is a method of advertising on the Internet:

First, list advertisement information about the goods or services of the service provider (that is, the advertising provider) is placed on a web site of the service provider (that is, the advertising provider) or on a related web site as a type of banner (that is, a banner type of advertisement).

Second, list a simple icon is used to place a service provider's advertisement information on a web site.

Third, pop-up advertisements (that is, advertisements that automatically output for a certain time on part of a monitor screen) are displayed on the display screen (for example, the monitor) of a user's terminal (for example, a computer) when the user moves to a web site.

Fourth, sales coupons or premiums are provided.

There are three ways that coupons or premiums are provided.

First, the service provider (that is, the advertisement provider) advertises directly on the web site of the advertisement provider.

Second, the service provider (that is, the advertisement provider) advertises indirectly on web sites related to its goods and services. Third, the service provider (that is, the advertisement provider) advertises through a specialized web site for goods or sale coupons.

There are advantages and disadvantages of each method of advertising, but they are essentially the same in providing the premiums or sale coupons to users.

However, one problem with the methods used until now for providing sale coupons or premiums is that they are limited to disposable advertisements, and continuous relations with the companies providing advertisements aren't maintained after the user subscribes through a corresponding advertisement.

Moreover, another problem with the current methods for providing sale coupons or premiums is that unnecessary work is created because the companies providing advertisements transmit the advertisements indiscreetly using E-mail accounts of a plurality of subscribed users.

Moreover, another problem with current methods for providing sale coupons or premiums is that a user who subscribes through an advertisement continually receives undesired advertisements and then wastes time unnecessarily and is subjected to an annoying inconvenience.

### DISCLOSURE OF THE INVENTION

Thus, an object of the present invention is to provide a system and method providing advertisement and technical skill premium by using network to be able to analyze a property of the user using the information of the subscribed user through the advertisement providing the sale coupon or the premiums and to select and provide only information suited to the corresponding user in various information.

Moreover, another object of the present invention is to provide the system and method providing the advertisement and the technical skill premium by using the network to be able to connect to desired information rapidly and easily, since the subscribed user can only be provided with information corresponding to a subject of interest through advertisements providing sale coupons or premiums.

Moreover still another object of the present invention is to provide the system and method providing the advertisement and the technical skill premium by using the network to be able to improve the overall effect of advertising. The advertisement provider requesting information for a plurality of users decreases the advertisement costs and potential problems with particular advertisements by excluding unnecessary users of those advertisements and operating only for a user concerned with the particular advertisement.

To achieve these objectives, in accordance with one preferred embodiment of the present invention, there is provided with the system and method for providing premiums by using network comprising the steps of previously registering premiums provided by at least one selected from a group consisting of member companies; previously storing advertisements corresponding to registered premiums; Storing at least one selected from a group consisting of questions; receiving selection information from a user's terminal about special premiums in at least one selected from a group consisting of the registered premiums; searching for the advertisements corresponding to the selected premiums; randomly extracting the appointed number of the questions in at least one selected from a group consisting of the stored questions; transmitting the searched advertisements and the extracted questions to the user's terminal; receiving answers corresponding to the questions from the user's terminal; storing the received answers; and transmitting information to the user's terminal about lottery results judging whether or not the user wins any premiums.

Moreover the network is at least one selected from a group consisting of wired communications network or wireless communications network.

Moreover the user's terminal is at least one selected from a group consisting of computers, mobile communication units, or PDA.

Moreover the step of randomly extracting the appointed number of the questions in at least one selected from a group consisting of the stored questions extracts both the questions related to at least one selected from a group consisting of the premiums and the member companies and the questions unrelated to the premiums and the member companies.

Moreover the step of storing the received answers comprises the steps of classifying the received answers according to the subject of the corresponding questions; and storing the classified answers and organizing them according to the corresponding subjects.

In accordance with another preferred embodiment of the present invention, there is provided with the system and method for providing advertisements by using network comprising the steps of randomly transmitting advertisements and extracted questions to user's terminal by using network; receiving answers corresponding to the questions from the user's terminal; storing the received answers; receiving advertisements requested from at least one selected from a group consisting of member companies and special companies by using network; appointing a marketing range using the advertisement requests; searching for the answers corresponding to the appointed marketing range in the stored answers; searching for user providing the searched answers; and transmitting advertisements to the user corresponding to the advertisement requests.

In accordance with still another preferred embodiment of the present invention, there is provided with the system and method for providing advertisements by using network comprising the steps of randomly transmitting advertisements and extracted questions to a user's terminal by using network; receiving answers corresponding to the questions from the user's terminal; storing the received answers; analyzing the stored answers using at least one selected from a group consisting of previously appointed type information; searching for user providing the answers; classifying the searched user to a suitable type in the type information; receiving the advertisement requests from at least of one selected from a group consisting of member companies and special companies by using network; judging the type information corresponding to the advertisement requests; searching for the classified user corresponding to the judged type information; and transmitting to the user the advertisements corresponding to the advertisement requests by using network.

Moreover the type information can comprise at least one selected from a group consisting of information about social activities, emotional type, lifestyle, hobbies, personal relations, and finances.

In accordance with still another preferred embodiment of the present invention, there is provided with the method for providing advertisements and technical skill premiums by using network comprising the member registration step of being connected to a central server that provides a bulletin board that is organized according to the type information or a day's schedule and serves as a database of information involving contents or advertisements corresponding to at least one selected from the group consisting of types of industries, enabling user to select the technical skill premium in at least one selected from a group consisting of the technical skill premiums, explaining the reason for the selection in relation to propensities, tendencies or sciences of divination of the user and performing the member registration; the information use step of connecting the user to sites of special types of industries that the user is interested in from among the various types of industries listed on the bulletin board, connecting the user to the web sites of service providers and reading or downloading any kind of the information; the all information display step of calculating frequency of a user's connection to a service provider's web site over a certain period on a information display board; the winning proof step of appointing recipients of technical skill premiums after a service provider selects the recipients of technical skill premiums based on the all information display step, analyzing the propensities of the recipients of the technical skill premiums using methods measuring the propensities, tendencies or sciences of the divination of the recipient of the technical skill premiums- the recipient of the technical skill premiums wants to obtain the technical skill premiums-, appointing the technical skill premiums suited to the recipient of the technical skill premiums, notifying the winning result to the recipient of the service provider; and the information accumulation step of accumulating the information about the propensities or the tendencies of the recipients of the technical skill premiums that the service provider analyzes and feeding back the information.

Moreover the technical skill premiums are at least one selected from the group consisting of premium about service and premium about goods. And the all information display step is to display the information of the frequency of the connection to the web site of the service provider over a certain period.

Moreover the service provider transmits a winning the premiums confirmation via e-mail to the recipient of the technical skill premiums, or displays the proof of winning the premiums on the screen, where the name of the won technical skill premiums is stated as well as at least one selected from a group consisting of the ID number of the winning person, the name of the winning person and the resident registration number of the winning person, after the service provider selects the recipient of the technical skill premiums based on the all information display step.

Also the service provider obtains data concerning the analyzed propensities of the users as well as the advertisement effect, and uses the data as marketing data by performing the input the step for analyzing the propensities of the users related to technical skill premiums before member registration.

Also the technical skill premiums provided by various types of industries listed on the bulletin board are classified according to the types based on the data for analyzing the propensities of the users, and the selection range of the technical skill premiums is then further subdivided according to propensities or tendencies of the users.

### BRIEF DESCRIPTION OF THE DRAWINGS

The above objectives and other advantages of the present invention will become more apparent in the following detailed descriptions of the preferred embodiments thereof with reference to the attached drawings, in which:

FIG. 1 is a schematic illustration of the system for providing advertisement and technical skill premium by using network in accordance with one preferred embodiment of the present invention;

FIG. 2 is a schematic flow chart illustrating a method for providing advertisement and technical skill premium by using network in accordance with another preferred embodiment of the present invention;

FIG. 3a and FIG. 3b are flow charts illustrating a method for providing advertisement and technical skill premium by using network in accordance with one preferred embodiment of the present invention;

FIG. 4a and 4b are flow charts illustrating a method for providing advertisement and technical skill premium by using network in accordance with one preferred embodiment of the present invention;

FIG. 5 is a flow chart illustrating how answer data from users is used as marketing data by member companies in accordance with one preferred embodiment of the present invention;

FIG. 6 is a flow chart illustrating a method of marketing using the answer data provided by users in accordance with one preferred embodiment of the present invention;

FIG. 7 is a flow chart illustrating a method of market analysis by analyzing a user's type based on answer data in accordance with one preferred embodiment of the present invention;

FIG. 8 is an illustration of the conditions used for a user's type based on the user's answer data in accordance with one preferred embodiment of the present invention;

FIG. 9 through FIG. 11 are illustrations of the screen display used for providing premiums to a user in accordance with one preferred embodiment of the present invention.

### DETAILED DESCRIPTION OF THE INVENTION

In the following, preferred embodiments of the present invention will be described in more detail with reference to the accompanying drawings, but it is understood that the present invention should not be limited to the following embodiments.

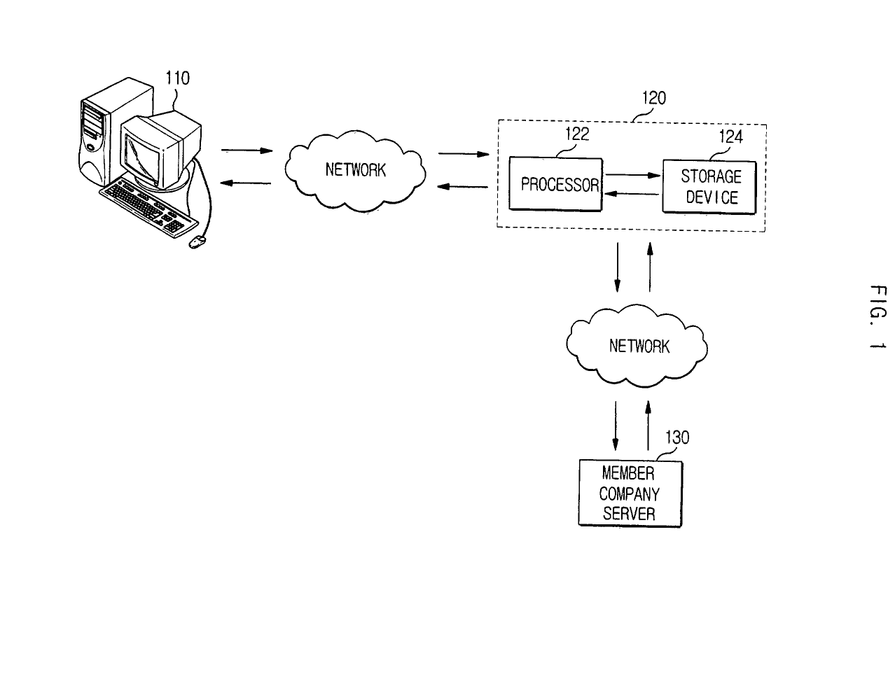

FIG. 1 is a schematic illustration of the system for providing advertisement and technical skill premium by using network in accordance with one preferred embodiment of the present invention.

Referring to FIG. 1, the system for providing advertisements and technical skill premiums comprises a user's terminal (110), a central server (120), and member companies of a server (130).

The user's terminal (110) consists of an apparatus able to connect to a central server (120) using communications functions like a computer, a mobile communication unit, a PDA. In the following, for convenience of explanation, the user's terminal (110) will be referred to as a computer.

The central server (120) provides the user connected through network with advertisements and premiums (for example, premiums about services, premiums about goods, and sales coupons) and applies the users to a target market by analyzing the individual information and property information of the user. The central server (120) comprises the processor and at least one selected from a group consisting of storage devices (124).

The member company server (130) provides server devices so that member companies and advertisement providers who request corresponding materials through a central server (120) may provide advertisements and premiums for a plurality of users. Member companies may comprise hospitals, academies, sports centers, and health and beauty clinics. The following is a brief description of the present invention with reference to FIG. 1.

The central server (120) stores corresponding information in the storage device (124) when the premiums are requested from at least one selected from a group consisting of member company server (130). The central server (120) outputs the corresponding advertisements when the user selects the corresponding premiums by linking the corresponding premiums and the corresponding advertisements of the member companies. The user connects to the central server (120)(herein referred to as the computer) using the user's terminal (110) connected with network and selects desired premiums from among a plurality of premiums registered with the central server (120).

The central server (120) extracts some questions (for example, three) from the advertisements of special companies corresponding to premiums selected by a user and from among a plurality of questions stored in a storage device (124), outputs the questions on the screen of the user's computer (110) and receives answers about the corresponding questions from the user's computer (110).

The corresponding questions transmitted from the central server (12) to the user's computer (110) are questions related to member companies providing premiums selected by the user, questions related to the corresponding premiums, or questions unrelated to either member companies or premiums. The corresponding answers received from the user's computer (110) are stored in the storage device (124) and afterwards used as output data concerning the target market.

Hereinafter, the central server (120) transmits a kind of lottery (for example, an instant lottery or lottery ticket) to the user's computer (110) in order to determine whether or not corresponding premiums will be provided to the user. If the corresponding lottery is an instant lottery, the central server (120) extracts the lottery information from the storage device (124) storing the lottery floatation career information and then determines whether or not the instant lottery is won.

In this case, methods can be used for determining whether or not the corresponding lottery is won such as automatically generating a number from a table of random numbers, or using a predetermined order of numbers according to a lottery flotation order.

Moreover, the user is informed of lottery results by means of outputting the results on the screen of the user's computer (110).

If the corresponding user wins corresponding premiums, the central server (120) transmits a congratulation message that includes an explanation of the method for obtaining the corresponding premiums.

Moreover, the central server (120) stores information about winning results by users in the storage device (124), and keeps track of the activities of the user.

The above-mentioned various storage devices may comprise one combined storage device or separate storage devices according to each property.

In the following, the system providing advertisement and technical skill premium by using network and the method for utilizing answers received from users for the target marketing is explained in detail with reference to a flow chart.

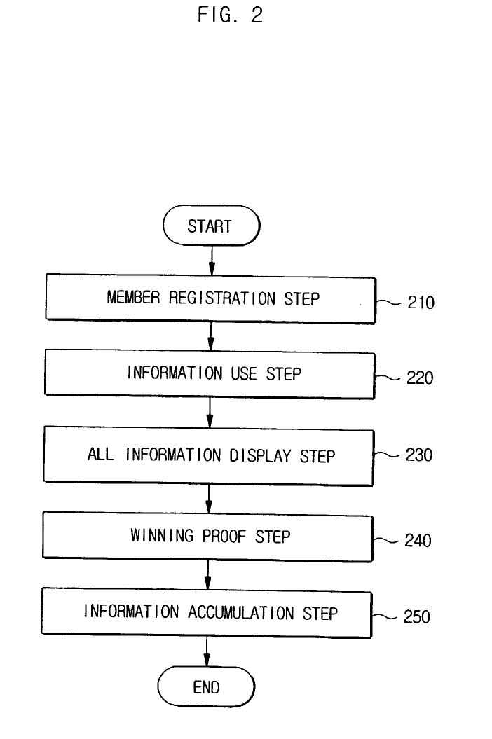

FIG. 2 is a schematic flow chart illustrating a method for providing advertisement and technical skill premium by using network in accordance with another preferred embodiment of the present invention.

Referring to FIG. 2, the central server performs the member registration step when a request is made for membership from one among a plurality of users in the step 210.

That is, a plurality of users connect to the web site of the operator providing information bulletins on which information about contents or advertisements of various types of industries (such as hospitals, academies, and photo studios) comprising a database according to type information or a day's schedule is displayed. The users select the special technical skill premiums that they want from among various kinds of technical skill premiums (for example, premiums about service or premiums about goods), explain the reason for their selection (using an oriental method of psychological analysis for determining a user's propensities or tendencies) and is registered as the new member.

For example, the various types of industries comprise the specialized types of industries in addition to normal types of industries (e.g., beauty salons, architectural or interior design firms, health clubs, flower shops, saunas, dance clubs, medical device manufacturers, hospitals, and academies).

Moreover, the technical skill premiums among the premiums able to be provided to users include premium about service. For example, a premium for a sauna may be for free bathing and a premium for an academy may be for a free course.

Moreover, the oriental method of psychological analysis has different preferences among similar kinds of premium about goods or premium about service according to users' propensities, tendencies or sciences of divination. For example, if the user receives the technical skill premium for a beauty salon for hair care, the technical skill premium can offer various specific services, such as a perm, hair straightening, dyeing, or a haircut. If a perm is selected, again various more specific types of service are offered such as a pink perm, dry perm, and setting perm, and roll perm.

In this way, the input step for determining the propensities of users is necessary before someone becomes the member in order to determine the premiums about service and premium about goods that the user will want to receive in the future. And then the service provider obtains information about the propensities of the user and effects of advertisements, and uses that information for marketing even if the user doesn't become a member.

Moreover, the range of possible technical skill premiums selected by a user in the future is further subdivided according to the propensities and tendencies of the user by classifying premium about service and premium about goods according to the types. Then the user can receive the desired technical skill premiums.

Moving on to another matter, the following is a detailed explanation of the method by which a minimum amount of identification information (for example, a name, phone number, resident number, or e-mail address) is input during the member registration step, and how the detailed information are collected separately when users are automatically provided with questions in another preferred embodiment of the present invention.

Moreover, when the user wins technical skill premiums, the user may input information in order to send goods to an appointed person. Generally, it is impossible to transfer the goods that have been won to another person because of the characteristics of technical skill premiums. Actually, however, the transfer of the technical skill premiums is possible according to the present invention. In order to do this, the user can input simple information about a plurality of applicants.

The central server performs the information use step when requests are made by any of a plurality of users in the step 220.

That is, there is the step of connecting the user to the central server after the user becomes the member, and then to a web site for a special type of industry among web sites of various types of industries list stored on the central server. The user is then connected to the web sites of the special service providers (that is member companies) in order to obtain information about special service providers. Therefore the user uses all information by reading and downloading the information on the web site of the special service providers.

At this time, when the user connects to a web site for a special type of industry at the step 220, the detailed classification about the service provider and regional classification are output on the display unit of the user's terminal. Here, for example, when the user connects to a hospital, the detailed classification about the service provider comprise information about the corresponding hospital such as whether it is for home care, pediatrics, psychiatry, or surgery, and the regional classification comprises an identification of the corresponding hospital's region, such as Kangnamgu, Sochogu, or Kwanakgu.

Through this classification, the user connects to the homepage of the special service provider, reads the detailed information concerning the corresponding service provider, or reads and downloads all information that the user wants.

The central server performs the all information display step by calculating the frequency that a user connects to the special service provider at the step 230.

That is, the central server renews the information displayed on the information display board shown on the web site of the special service provider and then calculates and displays the frequency that the user connects to the web site of the special service provider at the step 230.

For example, the calculation of the frequency that a user connects to a special service provider can be used as data for providing the technical skill premiums to recipients.

The central server performs the winning proof step when the central server detects a special user's winning results.

That is, the service provider appoints recipients of technical skill premiums based on the all information display step, determines the propensities of the recipient of technical skill premiums according to various methods of psychological analysis in order to select and obtain technical skill premiums that the recipient of technical skill premiums wants, appoints technical skill premiums that technical skill premiums recipient wants, and transmits a confirmation of winning results by e-mail to the user or displays the confirmation of winning results on the web site of the service provider.

In the step 240, as in the step 210, the propensities, tendencies or sciences of divination of the user are considered and then the quality of premiums about service and premiums about goods is improved and the preferences of recipients of technical skill premiums are used as information for serving a user in the future.

The names of technical skill premiums won by a particular person are displayed on the screen as the proof of winnings, as well as the user's name, ID number and resident number.

The step 240 will now be explained with an example.

When the user connects to the web site of a dental clinic several times to obtain information about a tooth, the central server calculates the frequency of connections and appoints a type of premium about service related to the work of the service provider. Here, the service provider's work relates to treating a decayed tooth and scaling.

In the step 250, the central server performs the information accumulation step. That is, as mentioned above, the step 250 is involves accumulating and feeding back the propensities or tendencies of the many recipients of premiums.

Accordingly, information about the preferences, opinions and satisfaction level of recipients of technical skill premiums is accumulated before and after the technical skill premiums are appointed. Based on this information, marketing methods or future distribution of technical skill premiums is organized. Moreover, the effectiveness of the service provider's advertisements is displayed based on the number of users who connect to the web site of the particular service provider, also, the user or the recipient of technical skill premiums gains a chance to receive desired premium about goods or premium about service.

Of course, the steps shown in FIG. 2 are performed as separate the step, but in fact various complicated steps can be preformed and in any case the special step is omitted.

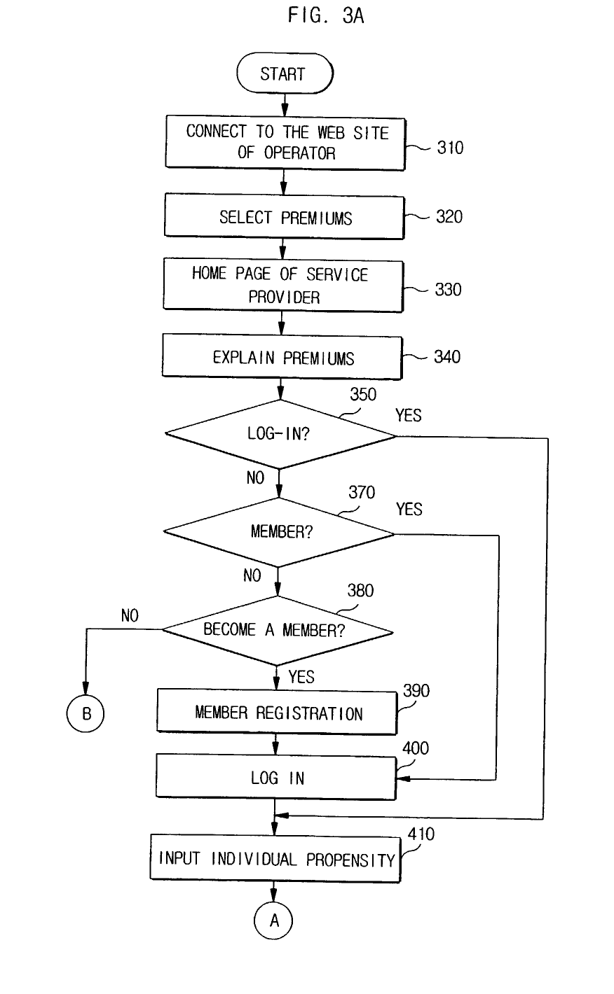

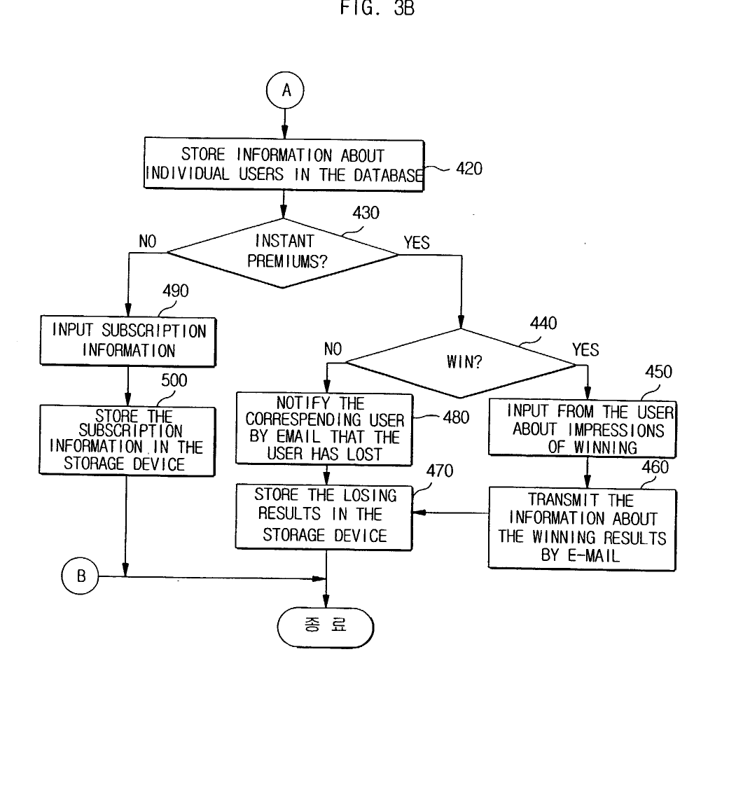

FIG. 3a and FIG. 3b are flow charts illustrating a method providing advertisement and technical skill premium by using network in accordance with one preferred embodiment of the present invention.

The following is an explanation of FIG. 3a and FIG. 3b, which together constitute FIG. 3.

Referring to FIG. 3, in the step 310 the central server receives a connection request from a user. In the step 320, the information is provided for selecting special premiums from among a plurality of premiums provided through a central server.

In the step 330, the central server enables the corresponding user to connect to the homepage of the service provider. And in the step 340, the central server provides the explanation of the premiums selected by the user.

In the step 350, the central server inspects whether or not the present corresponding user has logged on.

If the user hasn't logged on, the central server progresses to the step 370; otherwise, the central server progresses to the step 410.

In the step 370, the central server inspects whether or not the corresponding user is the member. If the user is not the member, the central server progresses to the step 380; otherwise, the central server progresses to the step 400.

In the step 380, the central server invites the user to become the member and inspects whether or not the user accepts the offer of membership.

If the user accepts the invitation to become a member, the central server progresses to the step 390. In the step 390, the central server inputs corresponding information necessary for the user to register as the member; otherwise, the series of the steps ends.

In the step 400, the central server receives login information from the user. Then the central server progresses to the step 410, in which the individual propensities of the user are input.

In the step 420, the central server stores information about individual users in the storage device. Then the central server progresses to the step 430, in which the central server inspects whether or not the previously appointed method for providing premiums selected by a user is a type of instant lottery. If the corresponding method is a type of instant lottery, the central server progresses to the step 440, otherwise, the central server progresses to the step 490.

In the step 440, the central server inspects whether or not the corresponding user wins the corresponding premiums.

If the user wins premiums, the central server progresses to the step 450, otherwise, the central server progresses to the step 480.

In the step 450, the central server requests input from the user about his/her impressions of winning. Then the central server progresses to the step 460, in which the central server transmits information about the winning results and the method by which the user can receive the premium by e-mail.

Then the central progresses to the step 470, in which the central server stores the winning results of the corresponding user in the storage device.

On the other hand, if the corresponding user does not win any premiums, the central server progresses to the step 480, in which the central server notifies the corresponding user by e-mail that the user has lost. The central server then progresses to the step 470, in which the central server stores the losing results in a storage device.

Of course, the proof of lottery results from the step 450 to the step 480 is performed using the display unit of the user's terminal as well as e-mail.

If the previously appointed method of providing premiums is not an instant lottery (but rather a lottery ticket, for example), the central server progresses to the step 430. In the step 490, subscription information is input. Then the central server progresses to the step 400, in which the central server stores the subscription information in the storage device.

We will now explain again briefly the method providing advertisement and technical skill premium by using network with reference to FIG. 3.

FIG. 3 is a detailed flow chart showing the step 210 as explained with reference to FIG. 2.

When the user connects to the central server, information is provided about advertisements of various types of industries (such as hospitals, academies, and photo studios) according to the user's type or the day's schedule on the bulletin board, which comprises a database displayed on the screen of the user's terminal.

Before the user becomes the member, the user selects the premiums about service and premiums about goods that the user wants to receive in the future. Then the user connects to the web site of the service provider that provides those premiums about service and premiums about goods.

The user selects the special technical skill premiums that the user wants from among various technical skill premiums and inputs the reason for the user' selection.

In addition, the procedure for becoming the member is preformed if the user wishes. Then the central server stores the information inputted by the user according to the oriental method of psychological analysis.

Moreover, the service provider can provide technical skill premiums to suitable users according to the method used for analyzing psychological propensities or tendencies, and then appoint the winning person fairly according to a previously determined lottery method.

In this situation, a user assigned an ID through member registration connects to the web site of the service provider and then reads or downloads various kinds of desired or necessary information.

Also, when the user reads or downloads various kinds of information several times, the frequency of the user's connection to the site is displayed on the information display board at the web site of the service provider, and the central server provides the service related to the type of industry of the service provider (for example, if the service provider is a dentist, the central server provides services related to treating teeth). If the frequency of connections rises to a certain level and the user obtains not only information but also a chance to obtain technical skill premiums that the user wants. Moreover, the service provider can improve the overall effectiveness of its advertisements by providing proofs to many unspecific persons.

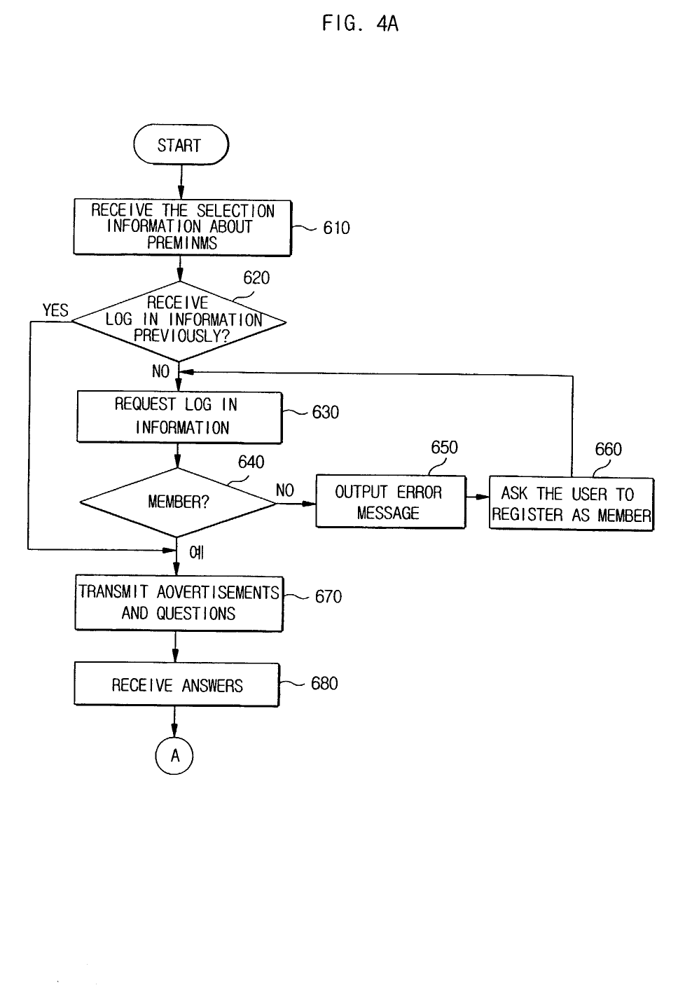

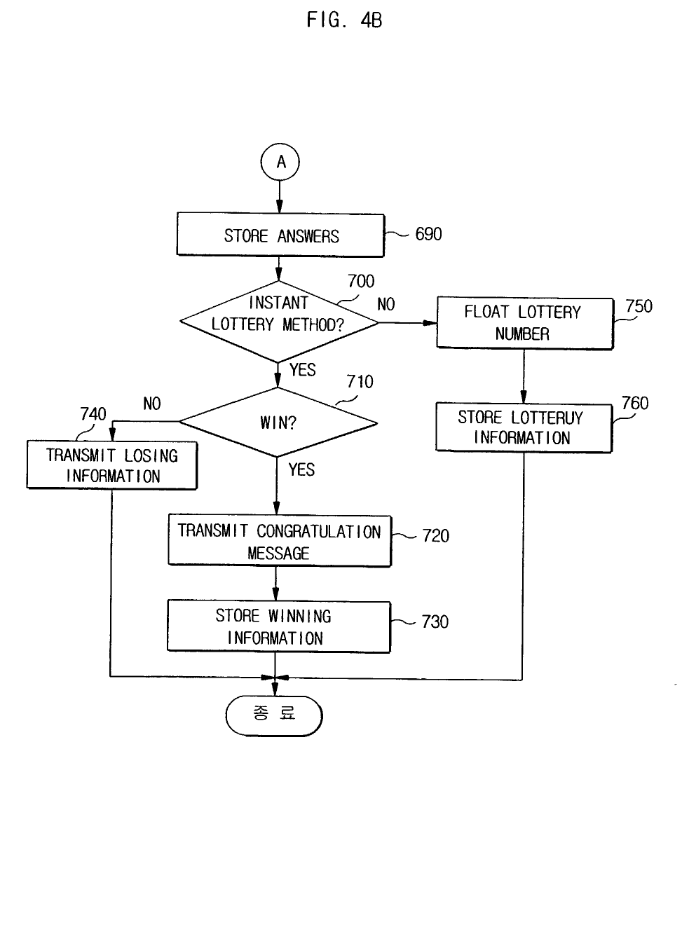

FIGS. 4a and 4b are flow charts illustrating a method for providing advertisement and technical skill premium by using network in accordance with one preferred embodiment of the present invention.

Referring to FIGS. 4a and 4b, in the step 610 the central server receives selection information about the premiums from a user connected to network. The kinds of the premiums provided by the system of the present invention for providing advertisements and premiums are premiums about service for the services of specialists and premiums about goods for the purchase of special goods. For convenience of explanation the kind of technical skill premium selected will be for having free plastic surgery to have eyelids with double folds.

In the step 620, the central server inspects whether or not login information has been received from the user.

If the login information has been received, the central server progresses to the step 670; otherwise, the central server progresses to the step 630.

In the step 630, the central server requests the user's login information In the step 630, a chatting window or corresponding web page is displayed on the screen of the user's computer to enable the user to input login information.

In the step 640, the central server inspects whether or not the login information received in the step 630 is valid.

If the login information is valid, the central server progresses to the step 670, otherwise, the central server progresses to the step 650.

In the step 650, the central server transmits an error message to the user's computer, such as, “The login information is incorrect. Try again after registering for a new membership.”. Then the central server progresses to the step 660, in which the central server asks the user to register as a member.

If the login information is not valid, the central server progresses to the step 630, in which the central server asks the user repeatedly to input login information. In this case, if only the user requests a form for registering as the member, the central server progresses to the step 660.

In the step 670, the central server transmits the advertisements and questions corresponding to the premiums selected by the user in the step 610.

The advertisements provided in the step 670 relate to premiums selected in the step 610. If the premium selected by the user is for double-fold eyelid surgery, an advertisement is output concerning that kind of plastic (for example, the names of recommended clinics, a rough sketch, a phone number).

The questions provided in the step 670 could be questions related to premiums selected by the user (for example, “Do you have a double-fold eyelid?” “How much does it cost to perform a double-fold eyelid operation?”), or questions unrelated to selected premiums (for example, “What kind of car do you want to buy?” “What type of car do you prefer?”).

These questions are stored in the storage device of the central server. Whenever the user selects the special premiums the user hopes to win, a certain number of questions are extracted (for example, three), which are either subjective or objective types of questions.

In the step 680, the central server receives the answers about the corresponding questions from the user's computer, and the central server then progresses to the step 690, in which the central server stores the corresponding answers in the storage device.

In the step 690, when the central server stores the answers to questions, the central server doesn't store both the answers and questions, but only the user's identification code and answers (for example, in the case of objective questions, a selected number of answers).

In the step 700, the central server inspects whether the kind of lottery used to determine whether premiums are won will be the instant lottery or the lottery ticket.

Of course, various kinds of lotteries can be used in addition to the two methods described, but for the convenience of explanation we will only explain these two methods.

If the type of lottery used is the instant lottery, the central server progresses to the step 710, otherwise, the central server progresses to the step 750.

In the step 710, the central server inspects whether or not the user wins the instant lottery that is provided. The method for judging whether or not the corresponding instant lottery is won can make use of automatically generated numbers based on a table of random numbers, the order appointed previously by the lottery floatation order or using the floated lottery according to the appointed time previously.

If the corresponding lottery is won, the central server progresses to the step 720, otherwise, the central server progresses to the step 740.

In the step 720, the central server transmits a congratulation message to the winning user's computer, and the central server then progresses to the step 730, in which the central server stores the winning information in the storage device.

In the step 720, the central server can request input from the user about his/her impressions of winning, and then prevent the winning of similar premiums if the user's impressions are not input according to certain predetermined conditions (for example, within one hour after transmitting the message notifying the user of winning).

Again, in the step 710, if the user does not win an instant lottery that is provided, the central server progresses to the step 740, in which the central server transmits the losing information about the corresponding premiums to the user's computer. the step 740 further comprises the step of storing information about failing to win a lottery in the storage device.

In the step 700, however, if the type of lottery provided to the user is a lottery ticket, the central server progresses to the step 750, in which the central server transmits the number of the lottery ticket to the corresponding user's terminal. Then the central server progresses to the step 760, in which the central server stores the lottery information sent to the user in the storage device.

The user can read at least one kind of lottery information provided to the user, store the information—(whether or not the corresponding lottery is won), and maintain records of the user's lottery experiences.

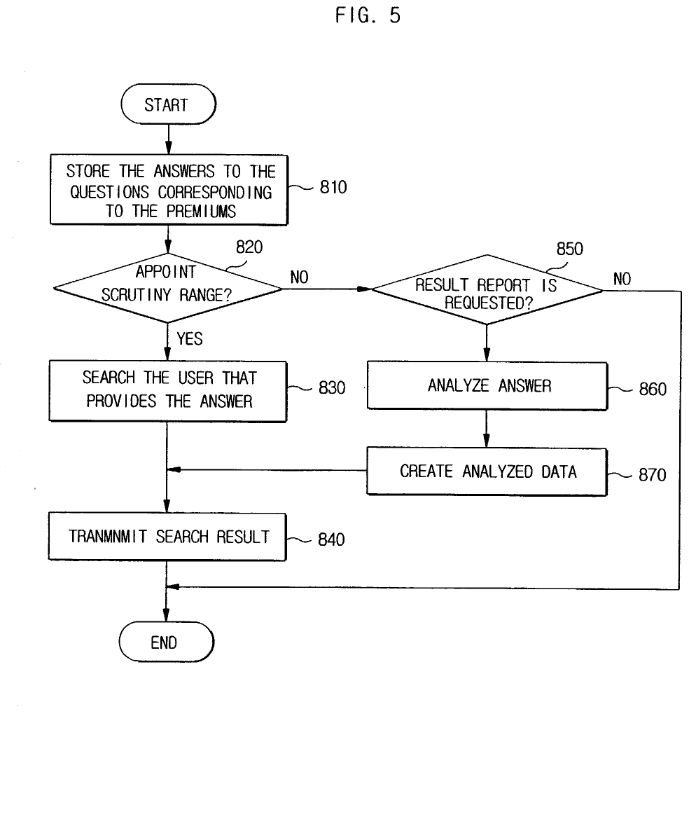

FIG. 5 is a flow chart illustrating how answer data from users is used as marketing data by member companies in accordance with one preferred embodiment of the present invention.

Referring to FIG. 5, in the step 810, the central server receives the answers to the questions related to special premiums (for example, the double-fold eyelid operation) from at least one selected from the group consisting of users and stores the answers in the storage device.

Of course, the answers received from the user can answer the question related to the corresponding premiums or the question unrelated to the corresponding premiums, but in the flow chart, only the answer about the question according to the corresponding premiums for creating the marketing data suited to the use of member companies providing the corresponding premiums is considered.

At this time, the method for determining whether or not the answer is suitable can use the identification code comprised in the corresponding answer.

In the step 820, the central server inspects whether or not the scrutiny range appointed by member companies is received. Of course, the method used for appointing the scrutiny range can be settled by phone or in the initial contract.

The scrutiny range decides the range of information that the corresponding member companies want to use as marketing data and can comprise information about the form and price.

If the scrutiny range appointed by the member company server is received, the central server progresses to the step 830, otherwise the central server progresses to the step 850.

In the step 830, the central server searches the user that provides the answer corresponding to the scrutiny range received through the step 820 and progresses to the step 840, in which the central server transmits the searched information to the member company server.

We will explain the present invention with the example of the method for searching the user corresponding to the scrutiny range through the step 810 and the step 840.

For example, if a plastic surgery clinic (a member company) wants to perform a “double-fold eyelid” operation for the cost of three hundred dollars, the member company requests the user information using the premiums for “double-fold eyelid fee” for finding suitable users.

At this time, the central server asks objective or subjective question such as, “how much does it cost to perform the ‘double-fold eyelid’ operation?” among in at least one selected from the group consisting of questions that are provided to the users that want to receive the corresponding premiums.

The user selects or inputs the desired price and the price information appointed by the user is stored in the storage device.

Hereinafter, the member companies appoint the scrutiny range revealing that the cost is more than three hundred dollars for performing the “double-fold eyelid” operation and transmit the scrutiny range to the central server.

The central server searches the users selecting the price comprised in the corresponding price range among from the answers, transmits the corresponding user information (for example, email address or phone number) to the member companies. Here the corresponding price range is comprised in the answers received from at least one selected from the group consisting of the users and stored in the storage device.

Of course, the information can be transmitted to the corresponding plastic surgery doctor by e-mail or post.

And, the member companies use the corresponding information as the target marketing data.

Again, referring to the step 820, if the appointed information about the scrutiny range isn't received, the central server progresses to the step 850. The central server inspects whether the result report about the corresponding answer is requested or not.

If the reported result corresponding to the answer is requested, the central server progress to the step 860, otherwise stop here the step.

Of course, the answer is transmitted to corresponding member companies without them requesting it.

In the step 860, the central server analyzes the answers received from at least one selected from the group consisting of the users according to the previously appointed method (for example, sex distinction classification, age classification, price classification) and progresses to the step 870, in which the central server create the analyzed data using the corresponding analyzed results.

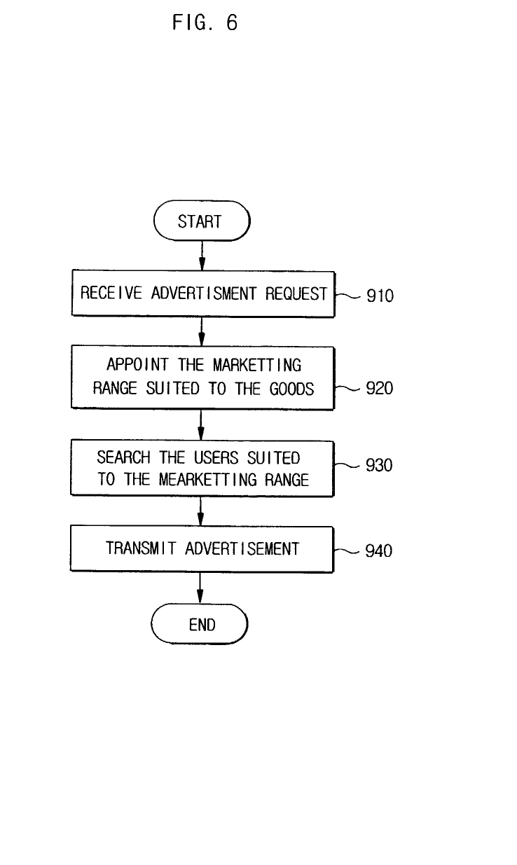

FIG. 6 is a flow chart illustrating a method of marketing using the answer data provided by users in accordance with one preferred embodiment of the present invention.

Referring to FIG. 6, in the step 910, the central server receives advertisement request from the advertisement provider. The advertisement provider requests the advertisement, appointing the special goods.

In the step 920, the central server appoints the marketing range suited to the goods that the advertisement provider has requested.

If the advertisement provider requests the advertisement of a new kind of notebook, the central server analyzes the relevant details (for example, the price, etc.) and appoints the marketing range for the notebook (a person in his twenties, monthly income of more than two thousand dollars, active job, etc.).

In the step 930, the central server analyzes property using the answer provided by the user for trying to win the premiums, and then searches the users suited to the marketing range appointed through the step 920 using the analyzed information.

In the step 940, the central server transmits the advertisement requested in the step 910 to the user searched in the step 930.

In the flow chart in FIG. 6, when the advertisement provider requests the advertisement about the special goods, the central server searches the users suited to the advertisement among the users analyzed according to property information using the answer information, and then uses the information from the user as marketing data. In addition to this method, the method for providing the advertisement to the user suited to the conditions appointed by the advertisement provider can be applied. Also in reverse, the method for inducing the advertisement to the advertisement provider by searching for information related to users that previously fit into the target marketing range.

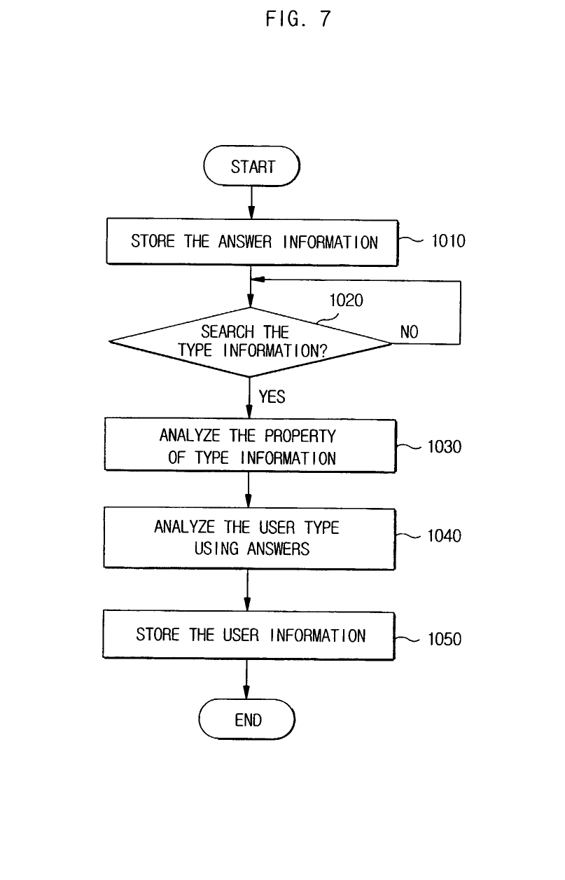

FIG. 7 is a flow chart illustrating a method of market analysis by analyzing a user's type based on answer data in accordance with one preferred embodiment of the present invention.

Using the system and method providing the advertisement and the technical skill premium by using the network of the present invention, the method for creating user groups according to type, and classifying the goods suited to the corresponding user groups, can be applied in addition to the method for creating the user groups according to the special goods.

Referring to FIG. 7, in the step 1010, the central server receives the answers to the questions about the selection of special premiums(for example, the “double-fold eyelid operation”) from at least one selected from the group consisting of the users and stores the answers in the storage device.

At this time, the questions asked of the user can comprise questions unrelated to the corresponding premiums (for example, “What color do you prefer?”) as well as questions related to the corresponding premiums.

In the step 1020, the central server inspects whether or not the previously appointed type information (for example, social type, active type, preference design type, character type, etc.) is searched.

The type information can be changed according to the needs of the central server, and anything can be registered as the type information if the anything has a reasonable standard without a frame that becomes set pattern standardization.

For example, the character type can be classified according to social type, progressive type, arrogant type, introspective type, etc. The reason can be classified by color preference, star sign,, western zodiac sign fortune, favorite flower, etc.

The central server does not only provide the questions related to the corresponding premiums, but also the questions unrelated to premiums when the corresponding user selects the special premiums. Then the central server collects the information about color preference, western zodiac sign fortune, etc. that the user provides.

Outlined below is the relation between the user's color preference and character type.

For example, the user who likes “pink” may be the elegant, refined, intellectual, social type, and may have prominent feminine qualities.

Whereas, the user who likes “red” may be the vigorous, driving type with an active character but little tenacity.

Character types can be generalized according to color preference.

Outlined below is the relation between oriental zodiac sign and character type. For example, when the user is born in the “Year of the Mouse”, the user is a social, quick-witted, imaginative, careful, honest, frugal type. But the user is aggressive and introspective. Also, when the user is born in the “Year of the Cow”, the user is a diligent, frugal, honest type. But the user is arrogant and authoritative.

As mentioned above, the user's character can be analyzed using fortune studies (Oriental studies) according to the animal sign under which one was born.

As a result, when the user's character type is analyzed and classified according to color preference, Oriental zodiac sign, western zodiac sign fortune, favorite flower, etc., certain differences are generated according to each condition. But the character type similar to the actual character of the user is selected through mutual supplement compensation.

In the step 1030, the central server analyzes the properties in order to classify at least one selected from the group consisting of the users according to the special type information. For example, the characteristic may be persistence, helpfulness, diligence, harmony, etc. in the case of a social type of person.

In the step 1040, the central server analyzes the corresponding user type using answers from at least one selected from the group consisting of the users stored in the step 1010.

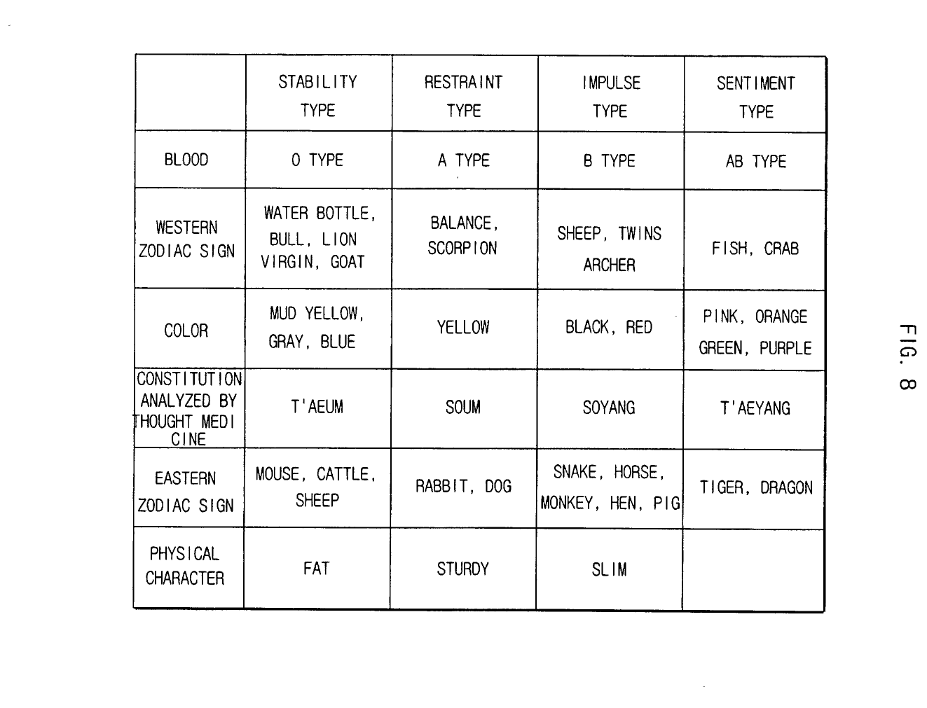

Hereinafter we will explain in detail the method for analyzing social type according to answers provided by the user with reference to FIG. 8.

In the step 1050. the central server classifies the users according to information analyzed in the step 1030, and stores the classified user information (for example, name, email address, phone number) in the storage device.

As mentioned above, using the user information classified according to the property of the type, the central server uses the information as the target marketing data. Herein after, let's explain in detail the example to be able to apply to the target marketing actually with reference to FIG. 8.

FIG. 8 is an illustration of the conditions used for a user's type based on the user's answer data in accordance with one preferred embodiment of the present invention;

As shown in FIG. 8, the information about blood type, western zodiac sign, color preference, the constitution analyzed by thought medicine, physical characteristics, etc. is used in analyzing the emotional type of the user, and classified with the mutual compensation and supplement.

When the user selects a premium such as “double-fold eyelid operation ticket”, a number of questions are displayed on the monitor.

The questions related to the corresponding premium can be comprised in the there questions and questions unrelated to the corresponding premium can be comprised in these questions.

If the above-mentioned questions comprise questions like, “What is your blood type?”, and the user answers “Type-A blood”, the user may be classified as having or being able to exercise a high level of restraint (restraint type) as shown in the illustration.

Moreover, when the user must answer questions repeatedly for different premiums, the questions are asked repeatedly and must be answered each time.

Questions asked repeatedly may include those regarding western zodiac sign, birthday (solar calendar), the constitution of the user, eastern zodiac sign, etc.

A user answering the above questions as follows: “Type-A blood”, “Scorpio”, “yellow”, “dog”, can be classified as having or exercising a high level of restraint.

When the user answers, “Type-A blood”, “Scorpio”, “red”, and “dog”, the user may be classified as normally having restraint but being impulsive in some situations.

This user information is used as target marketing data according to the conditions of FIG. 8.

For example, when the advertisement provider advertises a “noble metal ring” the user suited to the advertisement would be a user classified as having restraint according to the emotional analysis data.

That is, when the advertisement is displayed only to the “restraint type”, the substantial advertisement effect is not displayed, and the exclusion of “stability type” and “sentiment type” from the advertisement is a good method for improving the overall effect of the advertisement.

The prior art does not have the basis for analyzing the user type. And then when the advertisement provider sells the noble metal ring, the advertisement provider advertises to all user types including the “stability type”, the “restraint type” and the “sentiment type”. A greater advertisement cost is generated and the advertisement effect is not displayed.

The present invention improves the decreasing effect of the whole advertisement cost and advertisement effect because the present invention displays the advertisement only to suitable users according to character type.

Of course, as mentioned above, the user type is analyzed and classified separately according to various types like “social type”, “activity type”, “emotional type”, “lifestyle type”, “hobby type”, “personal relations type”, and “economic type”, and the analyzed and classified data is used for general target marketing.

For example, when searching for a suitable user to whom ski equipment could be effectively advertised, such factors as “hobby type”, “activity type”, “social type” and “economic type” should be considered.

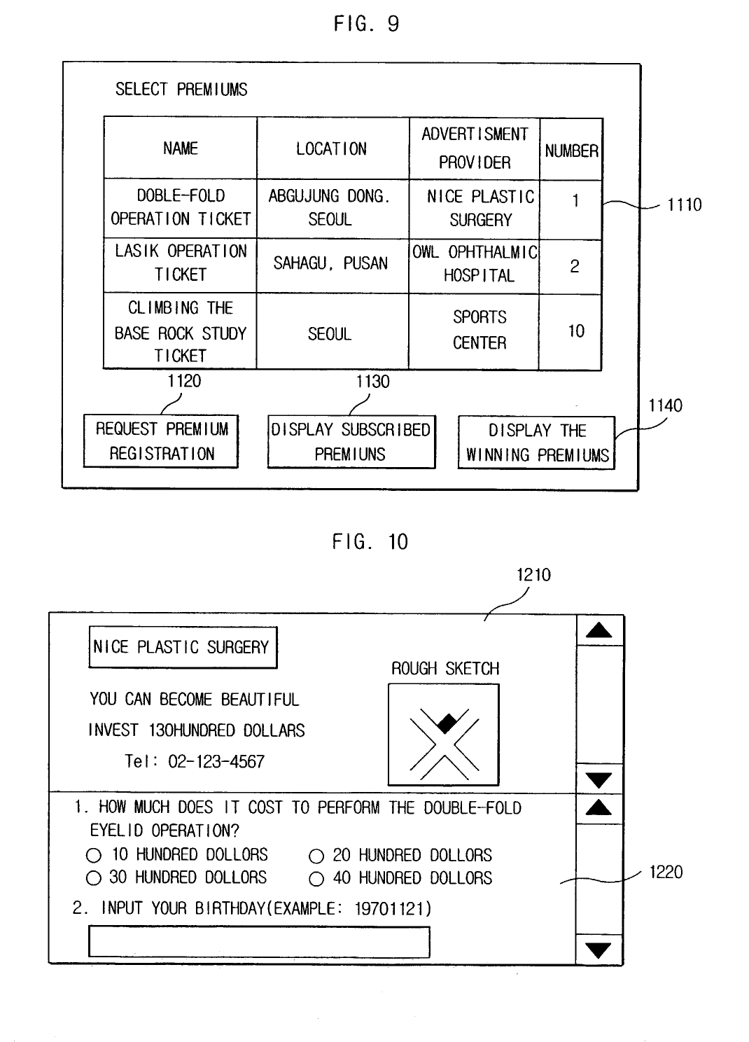

FIGS. 9 through FIG. 11 are illustrations of the screen display used for providing premiums to a user in accordance with one preferred embodiment of the present invention.

Referring to FIG. 9, the screen for providing the premiums to the user can comprise the premium information field for outputting at least one selected from the group of premium information registered through the provision of the member companies (1110), the premium registration request button for requesting the premium registration that the user wants (1120), the subscribed premiums display button for reading the premiums list subscribed by the user previously (1130), and the winning premiums display button for reading the premiums list won by the user previously (1140).

The premium information field (1110) is the file for outputting at least one selected from the group consisting of the premium information provided from the member companies, and can comprise the name information for appointing the corresponding premiums, the location information for proving the corresponding premiums, the information from member companies for proving the corresponding premiums, the number that provides the corresponding premiums.

Referring to FIG. 9, a plurality of premium information is displayed on the user's screen without local distinction. But the user selects the special location for the development of a commercial. Only premium information about the corresponding location can be displayed on the user's screen, displayed according to the kind of service such as hospital, school, beauty salon, etc.

Of course, classification according to the location and kind of service can be applied together.

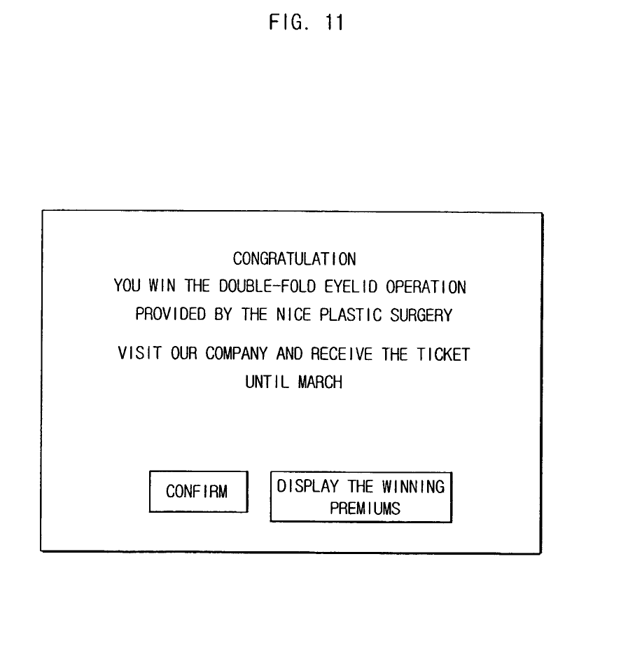

If the user selects the desirable premium in at least one selected from the group consisting of the premium information comprised in the premiums information field (1110), the screen display as shown in FIG. 10 is displayed on the user's screen.

The following, we explain in detail the present invention with the example wherein the user selects the “double-fold eyelid operation ticket” in the premium information field (1110).

Referring to FIG. 10, the advertisement field for displaying advertisements related to member companies providing the “double-fold eyelid operation ticket” that the user selects (1210), includes the question field for receiving the special information from the user (1220).

The question provided in the question field (1220) is the same question (for example, 3) that is extracted randomly from a plurality of questions stored in the storage device. This question is provided to the user. The corresponding question can be a question related to the premiums or member companies that the user selects (for example, “How much does it cost to perform the double-fold eyelid operation?”), or can be a question unrelated to the premiums or member companies that the user selects(for example, “What is your birthday?)

The central server can collect the various information about the user through the questions provided in the question field (1220) and apply the information to the various kinds of target marketing using the property of the user analyzed through the corresponding information.

Moreover, because the quantity able to be won in the corresponding premiums is limited, the winning person is appointed using an instant lottery or a lottery ticket, and the user tries to win the corresponding premiums by inputting the answer to the question provided. Here, selecting the corresponding premiums repeatedly for winning the corresponding premiums provides the question.

As a result, the advertisements from the member companies providing the corresponding premiums are exposed repeatedly to the users selecting the corresponding premiums through the advertisement field (1210), and the member companies look forward to improving their overall advertisement results as well as increasing public knowledge of their brands and trademarks.

If the user wins the corresponding premiums, the screen display, as shown in FIG. 11, is displayed on the user's screen.

Referring to FIG. 11, the information confirming the win the premiums selected by the user and the method for receiving the premiums are displayed.

Of course, for determining whether or not the user visiting for receiving the premiums is the winning person or not, information about the ID of the user and the resident registration number can be comprised.

Although the present invention has been described in terms of various embodiments, it is not intended that the invention be limited to these embodiments, Modification within the spirit of the invention will be apparent to those experienced in giving or receiving counseling.

### INDUSTRIAL APPLICABILITY

As mentioned above, the present invention can analyze the properties of the user information for subscribed users through advertisements providing the sale coupons or the premiums, and then only provide information to users that are suited to their particular interests.

Moreover, information desired by users can be accessed rapidly and easily because, through the use of advertisements providing sale coupons or premiums, users can be provided only with information corresponding to subjects of interest.

Moreover, when advertisement provider provides advertisements to a plurality of users, they can exclude users that have no interest in particular advertisements, and thereby decrease their advertising costs and the number of corresponding premiums that are wasted. Advertisements only have to be provided to users concerned with a particular product or service.

What is claimed is:

1. (amended)A method for providing premiums by using network, comprising the steps of:
previously registering the premiums provided by from at least one selected from a group consisting of member companies;
previously storing advertisements corresponding to the registered premiums;
storing at least one selected from a group consisting of questions;
receiving selection information from a user's terminal about special premiums in at least one selected from a group consisting of the registered premiums;
searching for the advertisements corresponding to the selected premiums
randomly extracting the appointed number of the questions in at least one selected from a group consisting of the stored questions;
transmitting the searched advertisements and the extracted questions to the user's terminal;
receiving answers corresponding to the questions from the user's terminal;
storing the received answers; and
transmitting information to the user's terminal about lottery results judging whether or not the user wins any premiums.

2. The method of claim 1,
wherein the network is at least one selected from a group consisting of wired communications network or wireless communications network.

3. The method of claim 1,
wherein the user's terminal is at least one selected from a group consisting of computers, mobile communication units, or PDA.

4. (amended) The method of claim 1,
wherein the step of randomly extracting the appointed number of the questions in at least one selected from a group consisting of the stored questions extracts both the questions related to at least one selected from a group consisting of the premiums and the member companies and the questions unrelated to the premiums and the member companies is extracted in the step of randomly extracting the appointed number of the questions in at least one selected from a group consisting of the stored questions.

5. (amended) The method of claim 1,
wherein the step of storing the received answers comprises the steps of:
classifying the received answers according to the subject of the corresponding questions; and
storing the classified answers and organizing them the classified answers according to the corresponding subjects.

6. (amended) A method for providing advertisements by using network, comprising the steps of:
randomly transmitting advertisements and extracted questions to user's terminal by using the network;
receiving answers corresponding to the questions from the user's terminal;
storing the received answers;
receiving advertisements requests from at least one selected from a group consisting of member companies and special companies by using the network;
appointing a marketing range using the advertisement requests;
searching for the answers corresponding to the appointed marketing range in the stored answers;
searching for user providing the searched answers; and
transmitting advertisements to the user corresponding to the advertisement requests.

7. (amended) A method for providing advertisements by using network, comprising the steps of:
randomly transmitting advertisements and extracted questions to a user's terminal by using the network;
receiving answers corresponding to the questions from the user's terminal;
storing the received answers;
analyzing the stored answers using at least one selected from a group consisting of previously appointed type information;
searching for user providing the answers;
classifying the searched user to a suitable type in the type information;
receiving the advertisement requests from at least of one selected from a group consisting of member companies and special companies by using the network;
judging the type information corresponding to the advertisement requests;
searching for the classified user corresponding to the judged type information; and
transmitting to the user the advertisements corresponding to the advertisement requests by using the network.

8. The method of claim 7,
wherein the type information comprises at least one selected from a group consisting of information about social activities, emotional type, lifestyle, hobbies, personal relations, and finances.

9. (amended) A system for providing premiums by using network, comprising:
a means for previously registering the premiums provided from at least one selected from a group of registered member companies;
a means for previously storing advertisements corresponding to the registered premiums;
a means for storing at least one selected from a group consisting of questions;
a means for receiving selection information from a user's terminal about special premiums in at least one selected from a group consisting of the registered premiums;
a means for searching for advertisements corresponding to the selected premiums;
a means for randomly extracting the appointed number of the questions in at least one selected from a group consisting of the stored questions;
a means for transmitting the searched advertisements and the extracted questions to the user's terminal;
a means for receiving answers corresponding to the questions from the user's terminal;
a means for storing the received answers; and
a means for transmitting lottery result information to the user's terminal judging whether or not the user wins any premiums storing at least one selected from a group consisting of questions.

10. The system of claim 9, further comprising:
a means for classifying the received answers according to the subject of the corresponding questions; and
a means for storing classified answers and organizing them according to the corresponding subjects.

11. (amended) A system for providing advertisements by using network, comprising:
a means for randomly transmitting advertisements and extracted questions to user's terminal by using the network;
a means for receiving answers corresponding to the questions from the user's terminal;
a means for storing the received answers;
a means for receiving advertisements requested from at least one selected from a group consisting of member companies and special companies by using the network;
a means for appointing a marketing range using the advertisement requests;
a means for searching for the answers corresponding to the appointed marketing range in the stored answers;
a means for searching for user providing the searched answers; and
a means for transmitting advertisements to the user corresponding to the advertisement requests.

12. (amended) A system for providing advertisements by using network, comprising:
a means for randomly transmitting advertisements and extracted questions to a user's terminal by using the network;
a means for receiving answers corresponding to the questions from the user's terminal;
a means for storing the received answers;
a means for analyzing the stored answers using at least one selected from a group consisting of previously appointed type information;
a means for searching for user providing the answers;
a means for classifying the searched user to a suitable type in the type information;
a means for receiving the advertisement requests from at least of one selected from a group consisting of member companies and special companies by using the network;
a means for judging the type information corresponding to the advertisement requests;
a means for searching for the classified user corresponding to the judged type information; and
a means for transmitting to the user the advertisements corresponding to the advertisement requests by using the network.

13. (amended) An apparatus for providing premiums by using network, comprising:
a storage device; and
a processor coupled to the storage device,
the storage device storing
a program for controlling the processor; and the processor operative with the program to previously register the premiums provided by from at least one selected from a group consisting of member companies;
previously store advertisements corresponding to registered premiums;
store at least one selected from a group consisting of questions;
receive selection information from a user's terminal about special premiums in at least one selected from a group consisting of the registered premiums;
search for the advertisements according to the selected premiums;
randomly extract the appointed number of the questions in at least one selected from a group consisting of the stored questions;
transmit the searched advertisements and the extracted questions to the user's terminal;
receive answers corresponding to the questions from the user's terminal;
store the received answers; and
transmit information to the user's terminal about lottery results judging whether or not the user wins any premiums.

14. The apparatus of claim 13,
wherein the processor also operates with the program to classify the received answers according to the subject of the corresponding questions; and
store the classified answers and organizing them according to the corresponding subjects.

15. (amended) An apparatus for providing premiums by using network, comprising:
a storage device; and
a processor coupled to the storage device,
the storage device storing
a program for controlling the processor; and
the processor operative with the program to randomly transmit advertisements and extracted questions to user's terminal by using the network;
receive answers corresponding to the questions from the user's terminal;
store the received answers;
receive advertisements requested from at least one selected from a group consisting of member companies and special companies by using the network;
appoint a marketing range using the advertisement requests;
search for the answers corresponding to the appointed marketing range in the stored answers;
search for user providing the searched answers; and
transmit advertisements to the user corresponding to the advertisement requests transmit advertisements and extracted questions randomly to a user's terminal by using the network.

16. (amended) An apparatus for providing premiums by using network, comprising:
a storage device; and
a processor coupled to the storage device,
the storage device storing
a program for controlling the processor; and
the processor operative with the program to randomly transmit advertisements and extracted questions to a user's terminal by using the network;
receive answers corresponding to the questions from the user's terminal;
store the received answers;
analyze the stored answers using at least one selected from a group consisting of previously appointed type information;
search for user providing the answers;
classify the searched user to a suitable type in the type information;
receive the advertisement requests from at least of one selected from a group consisting of member companies and special companies by using the network;
judge the type information corresponding to the advertisement requests;
search for the classified user corresponding to the judged type in formation; and
transmit to the user the advertisements corresponding to the advertisement requests by using the network.

17. A method for providing advertisements and providing technical skill premiums by using network, comprising:
the member registration step of being connected to a central server that provides a bulletin board that is organized according to the type information or a day's schedule and serves as a database of information involving contents or advertisements corresponding to at least one selected from the group consisting of types of industries, enabling user to select the technical skill premium in at least one selected from a group consisting of the technical skill premiums, explaining the reason for the selection in relation to propensities, tendencies or sciences of divination of the user and performing the member registration;
the information use step of connecting the user to sites of special types of industries that the user is interested in from among the various types of industries listed on the bulletin board, connecting the user to the web sites of service providers and reading or downloading any kind of the information;
the all information display step of calculating frequency of a user's connection to a service provider's web site over a certain period on a information display board;
the winning proof step of appointing recipients of technical skill premiums after a service provider selects the recipients of technical skill premiums based on the all information display step, analyzing the propensities of the recipients of the technical skill premiums using methods measuring the propensities, tendencies or sciences of the divination of the recipient of the technical skill premiums- the recipient of the technical skill premiums wants to obtain the technical skill premiums-, appointing the technical skill premiums suited to the recipient of the technical skill premiums, notifying the winning result to the recipient of the service provider; and
the information accumulation step of accumulating the information about the propensities or the tendencies of the recipients of the technical skill premiums that the service provider analyzes and feeding back the information.

18. The method of claim 17,
wherein the technical skill premiums is at least one selected from the group consisting of premium about service and premium about goods.

19. The method of claim 17,
wherein the all information display step is to display the information of the frequency of the connection to the web site of the service provider over a certain period.

20. The method of claim 17,
wherein the service provider transmits a winning the premiums confirmation via e-mail to the recipient of technical skill premiums, or displays the proof of winning the premiums on the screen, where the name of the won technical skill premiums is stated as well as at least one selected from a group consisting of the ID number of the winning person, the name of the winning person and the resident registration number of the winning person, after the service provider selects the recipient of the technical skill premiums based on the all information display step.

21. The method of claim 17,
wherein the service provider obtains data concerning the analyzed propensities of the users as well as the advertisement effect, and uses the data as marketing data by performing the input step for analyzing the propensities of the users related to technical skill premiums before member registration.

22. The method of claim 17,
wherein the technical skill premiums provided by various types of industries listed on the bulletin board are classified according to the types based on the data for analyzing the propensities of the users, and the selection range of the technical skill premiums is then further subdivided according to propensities or tendencies of the users.
